(19) United States
(12) Patent Application Publication
(10) Pub. No.: US 2019/0317928 A1
(43) Pub. Date: Oct. 17, 2019

(54) INFORMATION PROCESSING APPARATUS AND NON-TRANSITORY COMPUTER READABLE MEDIUM STORING INFORMATION PROCESSING PROGRAM

(71) Applicant: FUJI XEROX CO., LTD., TOKYO (JP)

(72) Inventor: Motoharu HIRATA, Kanagawa (JP)

(73) Assignee: FUJI XEROX CO., LTD., TOKYO (JP)

(21) Appl. No.: 16/355,832

(22) Filed: Mar. 17, 2019

(30) Foreign Application Priority Data
Apr. 13, 2018 (JP) 2018-077300

(51) Int. Cl. G06F 16/21; H04L 12/58; G06F 16/22

(52) U.S. Cl. CPC G06F 16/219; G06F 16/2246; H04L 51/063; H04L 51/16

(57) ABSTRACT

An information processing apparatus includes an outcome management unit that manages an outcome, a message management unit that manages a message corresponding to the outcome, and a presentation unit that classifies and presents the message according to a relationship between the outcome and the message.

### CROSS-REFERENCE TO RELATED APPLICATIONS

This application is based on and claims priority under 35 USC 119 from Japanese Patent Application No. 2018-077300 filed Apr. 13, 2018.

### BACKGROUND

### (i) Technical Field

The present invention relates to an information processing apparatus and a non-transitory computer readable medium storing an information processing program.

### (ii) Related Art

JP2002-297833A discloses a technique in which, in order to make information such as history of examination and a process usable before summarizing the information as a product, a knowledge information control device stores a conversation stream containing contents of a series of commitment data exchanged between persons concerning business through a network to achieve a business for solving problem. The knowledge information control device sequentially stores an object required to perform the business in a course ranging from the occurrence of a problem to the conclusion thereof in the state at the time at which the object was required. The knowledge information control device associates any conversation stream in the stored conversation stream with any object in the stored objects in response to an association request. The knowledge information control device outputs the information regarding any conversation stream and any object associated with each other in response to an associated information acquisition request.

### SUMMARY

A document or the like is created as an outcome in a project performed in a group of plural persons. The outcome is often created as a result of communication performed between persons concerning the project. The document as an outcome is managed. It is hard to check (review) history through which any document has been created.

Aspects of non-limiting embodiments of the present disclosure relate to an information processing apparatus and a non-transitory computer readable medium storing an information processing program capable of presenting messages exchanged as communication in the process of creating an outcome or thereafter.

Aspects of certain non-limiting embodiments of the present disclosure overcome the above disadvantages and other disadvantages not described above. However, aspects of the non-limiting embodiments are not required to overcome the disadvantages described above, and aspects of the non-limiting embodiments of the present disclosure may not overcome any of the problems described above.

According to an aspect of the present disclosure, there is provided an information processing apparatus including an outcome management unit that manages an outcome; a message management unit that manages a message corresponding to the outcome; and a presentation unit that classifies and presents the message according to a relationship between the outcome and the message.

### BRIEF DESCRIPTION OF THE DRAWINGS

Exemplary embodiment(s) of the present invention will be described in detail based on the following figures, wherein:

FIG. 1 is a conceptual module configuration diagram illustrating a configuration example in the present exemplary embodiment;

FIG. 2 is a diagram illustrating a system configuration example using the present exemplary embodiment;

FIG. 3 is a diagram illustrating a data structure example of an outcome information table;

FIGS. 4A and 4B are diagrams respectively illustrating data structure examples of a message information table and a message and outcome association table;

FIG. 5 is a diagram illustrating a process example according to the present exemplary embodiment;

FIG. 6 is a flowchart illustrating a process example according to the present exemplary embodiment;

FIG. 7 is a diagram illustrating a process example according to the present exemplary embodiment;

FIG. 8 is a diagram illustrating a process example according to the present exemplary embodiment;

FIG. 9 is a diagram illustrating a process example according to the present exemplary embodiment;

FIG. 10 is a flowchart illustrating a process example according to the present exemplary embodiment;

FIG. 11 is a diagram illustrating a display example according to the present exemplary embodiment;

FIG. 12 is a diagram illustrating a display example according to the present exemplary embodiment; and

FIG. 13 is a block diagram illustrating a hardware configuration example of a computer realizing the present exemplary embodiment.

### DETAILED DESCRIPTION

Hereinafter, with reference to the drawings, a description will be made of an exemplary embodiment for realizing the invention.

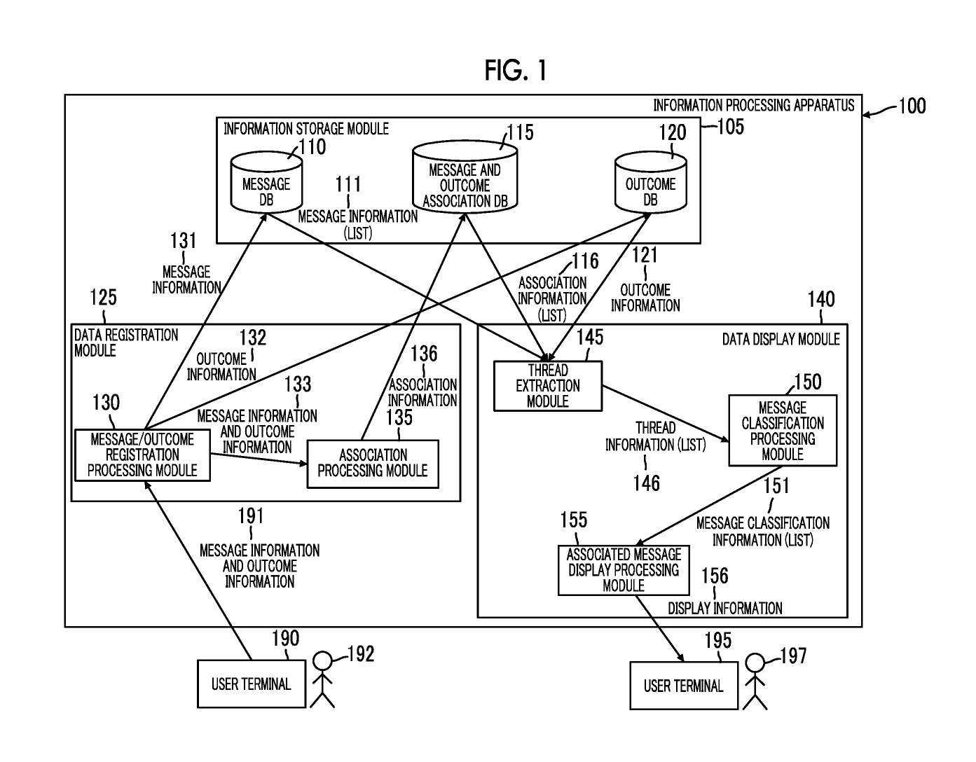

FIG. 1 is a conceptual module configuration diagram illustrating a configuration example according to the present exemplary embodiment.

The module generally indicates components such as software (computer program) or hardware which may be logically divided. Therefore, the module in the present exemplary embodiment indicates not only a module in a computer program but also a module in a hardware configuration. Therefore, in the present exemplary embodiment, a description will also be made of a computer program (a program causing a computer to execute each procedure, a program causing a computer to each unit, or a program a computer to realize each function), a system, and a method for functioning as such a module. However, for convenience of description, “storing”, “being stored”, or words equivalent thereto are used, but, these words indicate that a storage device stores data or a storage device is controlled to store data in a case where an exemplary embodiment is a computer program. A module may correspond to a function on a one-to-one basis, and, in installation, a single module may be configured with a single program, plural modules may be configured with a single program, and, conversely, a single module may be configured with plural programs. Plural modules may be executed by a single computer, and a single module may be executed by plural computers in a distributed or parallel environment. Other modules maybe included in a single module. Hereinafter, the term “connection” indicates not only physical connection but also logical connection (transmission and reception of data, a reference relationship between pieces of data, login, and the like). The term “setting in advance” indicates that setting is performed prior to a target process, and indicates not only that setting is performed before a process according to the present exemplary embodiment is started but also that, even after a process according to the present exemplary embodiment is started, setting is performed depending on a situation or a state at the time or a situation or a state hitherto in a case where a target process is not performed. In a case where there are “plural preset values”, the values may be different from each other, and two or more values may be the same as each other (of course, including all of the values). The description that “in a case of A, B is performed” indicates that “it is determined whether or not A is satisfied, and, in a case where it is determined that A is satisfied, B is performed”. However, this excludes a case where determination of whether or not A is satisfied is unnecessary. In a case where objects are listed such as “A, B, and C”, the objects are exemplarily listed unless otherwise mentioned, and a case where only one thereof (for example, only A) is selected is included.

A system or an apparatus also includes not only a case where plural computers, pieces of hardware, and apparatuses are configured to be connected to each other via a communication unit such as a network (including communication connection on a one-to-one basis) but also a case of being configured with a single computer, a single piece of hardware, and a single apparatus. The “apparatus” and the “system” are used as terms having an identical meaning. Of course, the “system” does not include systems that are merely a social “mechanism” (social system) which is an artificial arrangement.

Target information is read from a storage device, the process is performed, and a process result is written to the storage device for each process performed by each module or for each process in a case where plural processes are performed in a module. Therefore, description of reading for a storage device before a process and writing for the storage device after the process will be omitted. The storage device here may include a hard disk, a random access memory (RAM), an external storage medium, a storage device connected via a communication line, a register in a central processing unit (CPU), or the like.

An information processing apparatus 100 according to the present exemplary embodiment has a review support function based on coordination between an outcome and communication, and includes an information storage module 105, a data registration module 125, and a data display module 140 as exemplified in FIG. 1.

Here, the “outcome” is also generally referred to as a product, and indicates a document or the like completed as an outcome of a project, work, or the like. Specifically, the outcome corresponds to a deliverable, a program, a specification, or a design document. The outcome is not limited to a document such as printed paper, and also includes a document or a file in an electronic state. The outcome may be an outcome at that time, and also includes not only a finished product but also an intermediate version up to the finished product. The document is text data, numerical value data, graphic data, image data, moving image data, audio data, or a combination thereof, refers to an object which may be changed in the individual unit between systems or users as a target of storage, editing, and retrieval, and includes objects similar thereto. Specifically, the document includes a document created by a document creation program (so-called word-processing software), an image read by an image reading apparatus (scanner or the like), a web page, or the like.

As a message, for example, there is an electronic mail, chats, an electronic bulletin board, a notification using social media, or calling using an automatic voice response, and the calling may be performed by using, for example, Lync (registered trademark).

In the present exemplary embodiment, for example, the following process is performed. Particularly, this description (the description in this paragraph number) is made for the purpose of better understanding of the present exemplary embodiment, and is not intended to limit the present exemplary embodiment. It is obvious that the invention to be patented is not to be determined by using only this description part with respect to the contents disclosed in the Detailed Description of the Invention (Patent Law, Article 36, Paragraph 6, Section 1).

In a project performed in a group of plural people, work is often performed through communication of exchanging messages among members of the project. A document is created as an outcome, but the kind of communication which has been performed may be desired to be reviewed in a case where the document is created.

For example, in a system managing a version of an outcome (in a system not using the present exemplary embodiment), only vague related communication as the whole outcome from the first version to the latest version is understood, and it is hard to review a flow of updating a version such as history of having reached the latest version. Specifically, flows such as history of producing an outcome of the first version, a result of communication, and history of producing an outcome of the second version are not understood.

It is hard to determine which one of classifications such as “history” or “reaction” is indicated by each piece of communication, and the process thereof may not be efficiently understood.

The information processing apparatus 100 according to the present exemplary embodiment classifies a message group forming a topic linked with an outcome according to a relationship with the outcome. So-called classification modeling is performed. For example, a message with an outcome is classified as a “starting point”. Other messages are classified into “history”, a “reaction”, and a “separate discussion” (other discussions) according to a relative positional relationship from the starting point.

The information processing apparatus 100 presents communication related to an outcome in correlation with version management according to the classification of the messages.

Consequently, classifications (history, a reaction, and the like) of communication in an outcome can be understood in a differentiated manner. Even in a case where an outcome is formed of plural versions, a content of communication in each version can be understood.

The information storage module 105 includes a message database (DB) 110, a message and outcome association DB 115, and an outcome DB 120. The information storage module 105 manages a message, an outcome, and a relationship therebetween.

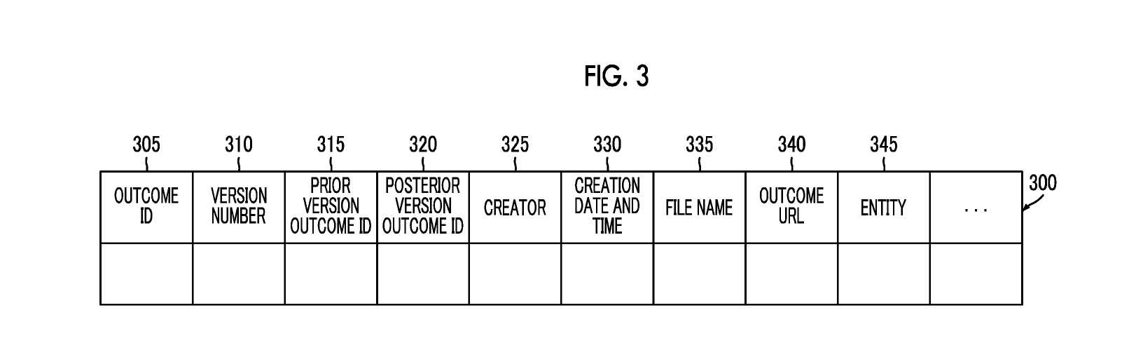

The outcome DB 120 is connected to a message/outcome registration processing module 130 of the data registration module 125 and a thread extraction module 145 of the data display module 140, and receives outcome information 132 from the message/outcome registration processing module 130, and delivers outcome information 121 to the thread extraction module 145. The outcome DB 120 manages outcomes. Specifically, the outcome DB 120 manages a version of an outcome. For example, the version is managed by using an “outcome identification (ID)” for identifying each outcome or a “version number”. For example, the version is managed by using information such as a “storage destination”, a “file name”, or an “entity of an outcome (file)”. Regarding outcomes of which outcome IDs match each other, versions are regarded to be different from each other in an identical outcome, and an outcome having the largest version number is regarded to be the latest outcome. The term “managing a version of an outcome” indicates a function in which an outcome such as a document has versions such as the first version and the second version, the series of versions is preserved from a source outcome (first version), and return to any version may be performed. Aversion is also referred to as an outcome (specifically, a document such as a first version). In other words, only the latest version is not an outcome, that is, the latest version is an outcome, and the past version is also an outcome. The outcome DB 120 stores, for example, an outcome information table 300. FIG. 3 is a diagram illustrating a data structure example of the outcome information table 300. The outcome information table 300 has an outcome ID field 305, a version number field 310, a prior version outcome ID field 315, a posterior version outcome ID field 320, a creator field 325, a creation date and time field 330, a file name field 335, an outcome URL field 340, an entity field 345, and the like. The outcome ID field 305 stores information (outcome ID) for uniquely identifying an outcome in the present exemplary embodiment. The version number field 310 stores a version number. The prior version outcome ID field 315 stores an outcome ID in a prior version. The posterior version outcome ID field 320 stores an outcome ID in a posterior version. The creator field 325 stores a creator. The creation date and time field 330 stores creation date and time (which may be year, month, day, hour, minute, second, second or less, or a combination thereof). The file name field 335 stores a file name of the outcome. The outcome URL field 340 stores a URL in which an outcome is stored. The entity field 345 stores the entity of the outcome. Either the outcome URL field 340 or the entity field 345 may be provided.

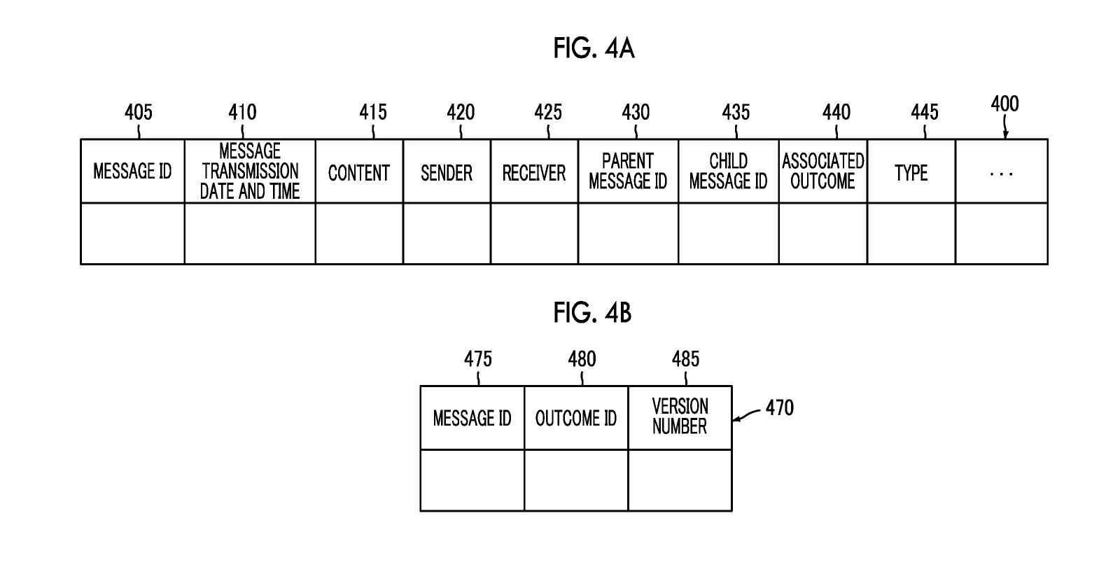

The message database 110 is connected to the message/outcome registration processing module 130 of the data registration module 125 and the thread extraction module 145 of the data display module 140, and receives message information 131 from the message/outcome registration processing module 130, and delivers message information (list) 111 to the thread extraction module 145. The message database 110 manages messages exchanged between members. A corresponding message is included in an outcome in the outcome DB 120. For example, a text based message is managed by using a “message ID” for uniquely identifying the message and “message information (text, a contributor, the contribution date and time, and the like)”. Each message may hold a “parent message ID” and a “child message ID”, and thread information (tree structure) is built according to this association. For a single message, the number of parent message IDs is 0 or 1, and the number of child message IDs is 0 to N. In a case where an outcome is attached, an “associated outcome ID” may also be held. The number thereof is 0 to N. The message database 110 stores, for example, a message information table 400. FIG. 4A is a diagram illustrating a data structure example of the message information table 400. The message information table 400 has a message ID field 405, a message transmission date and time field 410, a content field 415, a sender field 420, a receiver field 425, a parent message ID field 430, a child message ID field 435, an associated outcome field 440, a type field 445, and the like. In the present exemplary embodiment, the message ID field 405 stores information (message ID) for uniquely identifying a message. The message transmission date and time field 410 stores the transmission date and time of the message. The content field 415 stores a content of the message. The sender field 420 stores a sender of the message. The receiver field 425 stores a receiver of the message. The parent message ID field 430 stores a parent message ID. The child message ID field 435 stores a child message ID. The associated outcome field 440 stores an outcome (a URL or the like of a document) attached to the message. The type field 445 stores the type (a starting point, history, a reaction, or a separate discussion) as a classification result.

The message and outcome association DB 115 is connected to an association processing module 135 of the data registration module 125 and the thread extraction module 145 of the data display module 140, receives association information 136 from the association processing module 135, and delivers association information (list) 116 to the thread extraction module 145. The message and outcome association DB 115 manages a combination of a “message ID”, an “outcome ID”, and a “version number”. The message and outcome association DB 115 stores, for example, a message and outcome association table 470. In FIG. 4B, the message and outcome association table 470 has a message ID field 475, an outcome ID field 480, and a version number field 485. The message ID field 475 has a message ID correlated with an outcome. The outcome ID field 480 stores an outcome ID of the outcome correlated with the message. The version number field 485 stores a version number of the outcome. On the basis of the message and outcome association table 470, an “outcome ID” and “version number” may be extracted from a “message ID”, and, conversely, the “message ID” maybe extracted from the “outcome ID” and the “version number”.

The data registration module 125 includes the message/outcome registration processing module 130 and the association processing module 135. The data registration module 125 stores an outcome, a message, and association information of the outcome and the message in the information storage module 105 in response to an operation of a contributor 192 in a user terminal 190.

The message/outcome registration processing module 130 is connected to the message database 110 and the outcome DB 120 of the information storage module 105, the association processing module 135, and the user terminal 190, and receives message information and outcome information 191 from the user terminal 190, delivers the message information 131 to the message database 110, delivers the outcome information 132 to the outcome DB 120, and delivers message information and outcome information 133 to the association processing module 135.

The association processing module 135 is connected to the message and outcome association DB 115 of the information storage module 105 and the message/outcome registration processing module 130, and receives the message information and outcome information 133 from the message/outcome registration processing module 130, and delivers association information 136 to the message and outcome association DB 115. The association processing module 135 performs association between messages according to a message response operation.

The association processing module 135 registers an outcome (file) or updates a version in association with a message. Specifically, “registering an outcome in association with a message” includes registering an outcome directly attached to a message in association with the message or registering a document stored in a “location storing the document” described in a message in association with the message. A “location storing a document” is, for example, a URL. Regarding “update of a version”, in a case where a document with an original version is edited and registered, a version of the document is updated.

A description will be made of a process example in the data registration module 125.

(1) The contributor 192 registers any message as appropriate by using the user terminal 190.

In this case, the message/outcome registration processing module 130 accumulates the message in the message database 110. In a case where an outcome is attached, the outcome is accumulated in the outcome DB 120.

(2) In a case where an outcome is attached, the association processing module 135 accumulates a “message ID”, an “outcome ID”, and “version number” in the message and outcome association DB 115.

The data display module 140 includes the thread extraction module 145, a message classification processing module 150, and an associated message display processing module 155. The data display module 140 classifies a message according to a relationship between an outcome and the message in response to an operation of a viewer 197 in a user terminal 195, and presents the message to the viewer 197.

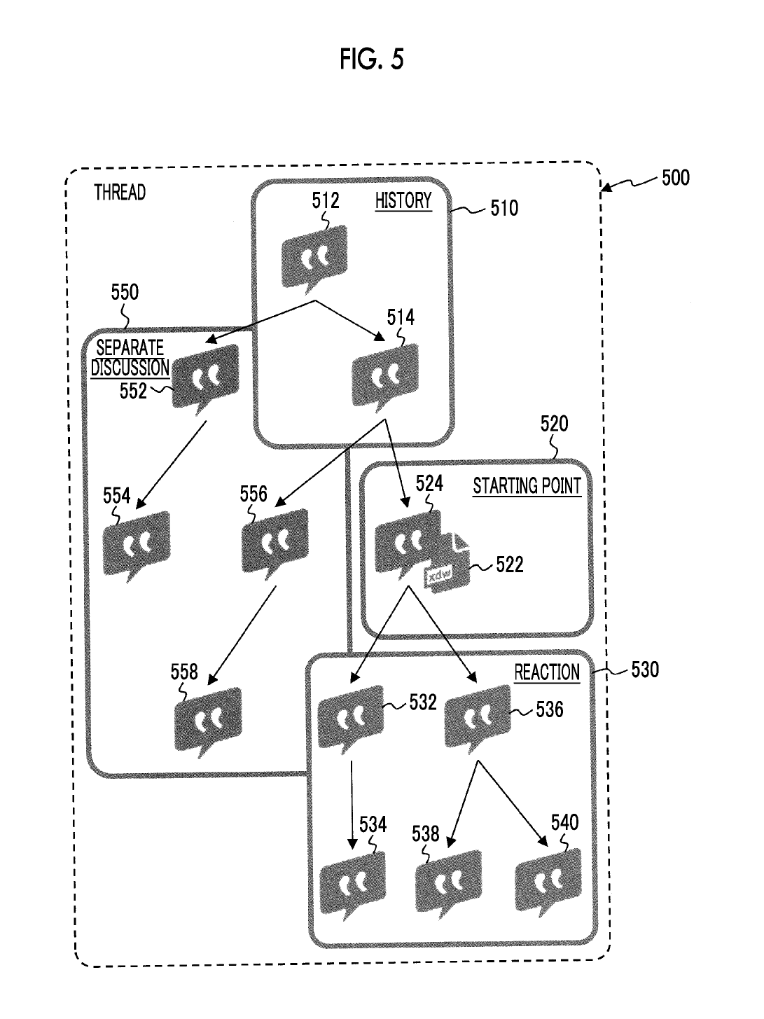

The thread extraction module 145 is connected to the message database 110, the message and outcome association DB 115, and the outcome DB 120 of the information storage module 105, and the message classification processing module 150, and receives the message information (list) 111 from the message database 110, receives the association information (list) 116 from the message and outcome association DB 115, receives the outcome information 121 from the outcome DB 120, and delivers thread information (list) 146 to the message classification processing module 150. The thread extraction module 145 generates a thread having a tree structure according to a relationship between messages by using a message, an outcome, and a relationship between the message and the outcome. Specifically, a tree structure is formed such that an original message is set to a parent node, and a message given in response to the message is set to a child node. A method of forming a tree structure of a message group will be described later by using an example illustrated in FIG. 5. An outcome may be correlated with a node of the tree structure.

The message classification processing module 150 is connected to the thread extraction module 145 and the associated message display processing module 155, and receives the thread information (list) 146 from the thread extraction module 145, and delivers message classification information (list) 151 to the associated message display processing module 155. The message classification processing module 150 classifies a message according to a relationship between an outcome and the message. Here, a “relationship between an outcome and a message” may include one or more of a starting point, history, a reaction, or a separate discussion.

In a message group having a tree structure, a message associated with a preset outcome may be set to a starting point. Here, the “preset outcome” may be, for example, an outcome with a first version, an outcome with another version, or an outcome with a version designated by a user. The term “being associated with an outcome” includes a case where an outcome is directly attached to a message or a case where a location in which a document is stored is described in a message.

In the message group, messages from a message at a root node to a message at a node before a message serving as a starting point may be set as history.

In the message group, a message at a descendant node after a message serving as a starting point may be set as a reaction.

In the message group, a message at a node not having a relationship of history or a reaction with a message serving as a starting point may be set as a separate discussion. In other words, a message in a node which does not have a relationship of “history” with a message serving as a “starting point” and does not have a relationship of a “reaction” with the message serving as the “starting point” may be set as a message of a “separate discussion”.

The associated message display processing module 155 is connected to the message classification processing module 150 and the user terminal 195, and receives the message classification information (list) 151 from the message classification processing module 150, and delivers display information 156 to the user terminal 195. The associated message display processing module 155 presents a process result (classification result) in the message classification processing module 150 to the user terminal 195.

The associated message display processing module 155 may present a message classified into relationships for each outcome.

The associated message display processing module 155 may present messages in other outcomes associated with a message.

A description will be made of a process example in the data display module 140.

(1) The viewer 197 selects any outcome by operating the user terminal 195, and requests the information processing apparatus 100 to display an associated message.

(2) In this case, the thread extraction module 145 acquires a list of associated pairs of a “message ID” and a “version number” by using an “outcome ID” from the message and outcome association DB 115.

For each message ID, all pieces of message information of a thread including a message having the message ID are acquired from the message database 110.

(3) The message classification processing module 150 classifies each message into a “starting point”, “history”, a “reaction”, and a “separate discussion” for each thread.

(4) The associated message display processing module 155 performs a process of combining an outcome with a message for each message classification of each thread on the basis of the classification information (a “starting point”, “history”, a “reaction”, and a “separate discussion”), and displays a combination result to the viewer 197 of the user terminal 195.

The user terminal 190 is connected to the message/outcome registration processing module 130 of the data registration module 125 in the information processing apparatus 100, and delivers message information and outcome information 191 to the message/outcome registration processing module 130.

The contributor 192 operates the user terminal 190, and registers a message. An outcome may be attached to the message.

The user terminal 195 is connected to the associated message display processing module 155 of the data display module 140 in the information processing apparatus 100, and receives the display information 156 from the associated message display processing module 155. The user terminal 190 and the user terminal 195 correspond to personal computers (including notebook PCs) or portable information terminals having a communication function.

The viewer 197 operates the user terminal 195 so as to view a message associated with any outcome.

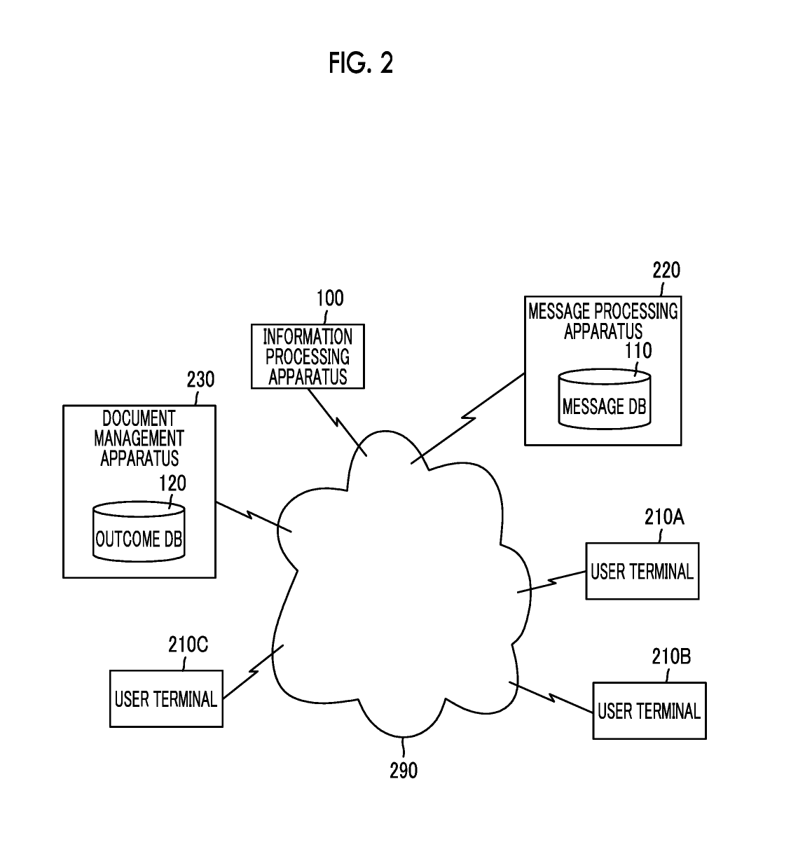

FIG. 2 is a diagram illustrating a system configuration example using the present exemplary embodiment.

A user terminal 210A, a user terminal 210B, a user terminal 210C, a message processing apparatus 220, and a document management apparatus 230 are connected to each other via a communication line 290. The communication line 290 may be a wireless line, a wired line, or a combination thereof, and may be, for example, the Internet, an intranet as a communication infrastructure.

The user terminal 210 may be the user terminal 190 or the user terminal 195.

The message database 110 and the outcome DB 120 of the information processing apparatus 100 in the example illustrated in FIG. 1 may be provided outside the information processing apparatus 100, and, for example, the message database 110 may be provided in the message processing apparatus 220, and the outcome DB 120 may be provided in the document management apparatus 230. For example, the document management apparatus 230 is also referred to as a document management repository.

The functions of the information processing apparatus 100, the message processing apparatus 220, and the document management apparatus 230 may be realized by a cloud service.

A project is formed by users of the user terminal 210A, the user terminal 210B, and the user terminal 210C, and, in the process of project progress, messages are exchanged among the users by using the message processing apparatus 220. In a case where a document is created, the document is stored in the document management apparatus 230, and other users are notified of the message storage via a message. Of course, in the creation of a document, the document is often edited to go through several versions.

For example, in a case where a document which is an outcome of the project is created, a leader (viewer 197) of the project desires to review the previous discussions. Therefore, a message is classified according to a relationship between a document and the message by using the information processing apparatus 100, and is presented to be provided for the review.

FIG. 5 is a diagram illustrating a process example according to the present exemplary embodiment.

Any user participating in a certain project contributes a message to a certain task (information sharing space). The message is the minimum unit of a communication object having text as a body. The message may include supplementary information such as the contributing user and time in addition to the text. Messages maybe associated with each other through a message response operation. A response is indicated by an arrow in FIG. 5. A response source is referred to as a parent, and a response message is referred to as a child. An outcome may be registered in the outcome DB 120 in association with a message.

A thread 500 is a message group having a tree structure built by a response about a message to any message. A root message is necessarily uniquely defined for any thread.

In any project, the following exchange of messages is assumed to occur.

A message 514 and a message 552 are transmitted in response to a root message 512, and thus a parent-child relationship is generated between the root message 512 and the messages 514 and 552.

A message 524 and a message 556 are transmitted in response to the message 514, and thus a parent-child relationship is generated between the message 514 and the messages 524 and 556.

A message 554 is transmitted in response to the message 552, and thus a parent-child relationship is generated between the message 552 and the message 554.

A message 532 and a message 536 are transmitted in response to the message 524, and thus a parent-child relationship is generated between the message 524 and the messages 532 and 536.

A message 558 is transmitted in response to the message 556, and thus a parent-child relationship is generated between the message 556 and the message 558.

A message 534 is transmitted in response to the message 532, and thus a parent-child relationship is generated between the message 532 and the message 534.

A message 538 and a message 540 are transmitted in response to the message 536, and thus a parent-child relationship is generated between the message 536 and the messages 538 and 540.

The message 524 is attached with an outcome 522, or a URL which is a storage location of the outcome 522 is included in a described content.

Therefore, the thread 500 having a tree structure includes the message 514 and the message 552 as children of the root message 512, the message 524 and the message 556 as children of the message 514, the message 554 as a child of the message 552, the message 532 and the message 536 as children of the message 524, the message 558 as a child of the message 556, the message 534 as a child of the message 532, and the message 538 and the message 540 as children of the message 536.

The thread 500 is classified into four models, that is, history 510, a starting point 520, a reaction 530, and a separate discussion 550 through a process performed by the information processing apparatus 100. This is a classification result of a message for an outcome (outcome 522). Specifically, the message 524 in which an outcome occurs is classified as the starting point 520, messages from the root message 512 which is a root node to the message 524 are classified as the history 510, a descendant of the message 524 is classified as the reaction 530, and others are classified as the separate discussion 550.

The starting point 520 is a message serving as a reference for this model. The starting point 520 indicates a message attached with an outcome (for example, the outcome 522), or a message attached with a repository URL in which the outcome is stored (the message in which the repository URL is described).

The history 510 is a message group indicating history reaching creation and attachment of an outcome. The history 510 indicates a message group corresponding to an ascendant (a response source chain to the root message) of the starting point 520.

The reaction 530 is a message group indicating a reaction to an outcome. The reaction 530 indicates a message group corresponding to a descendant of the starting point 520.

The separate discussion 550 is included in an identical thread but is a message group having no direct relation to an outcome (for example, the outcome 522). The separate discussion 550 indicates a message group (descendants other than the starting point when viewed from the history) not included in the history, the starting point, and the reaction.

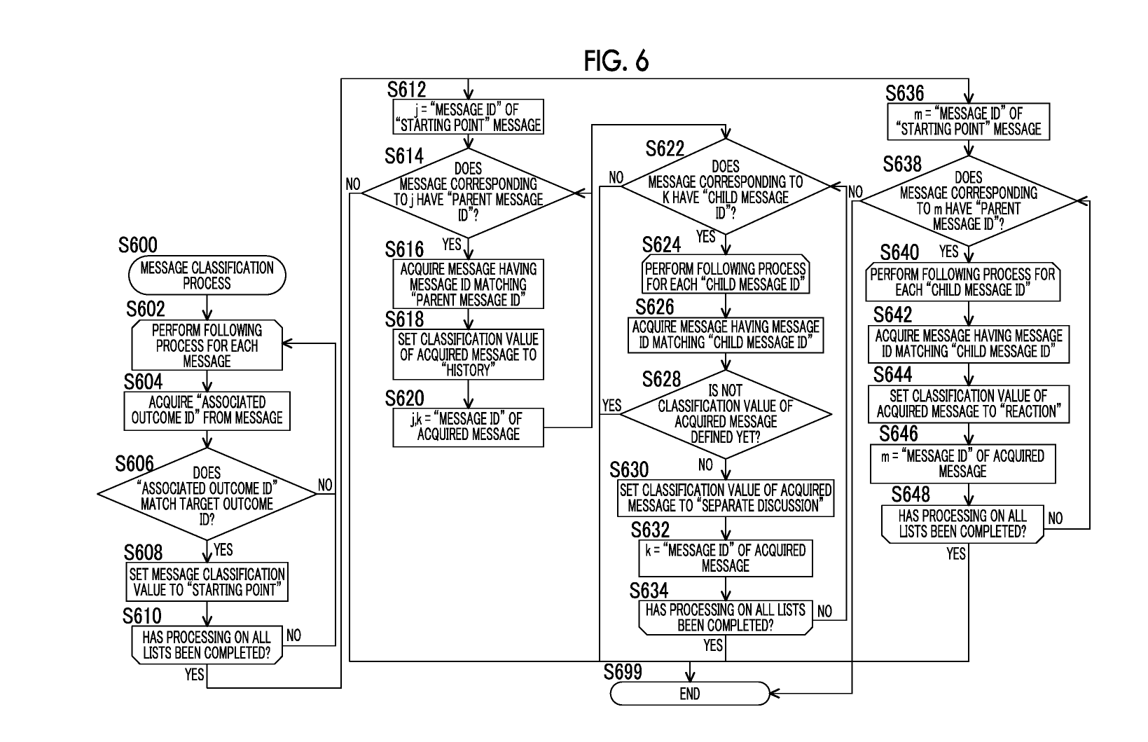

FIG. 6 is a flowchart illustrating a process example according to the present exemplary embodiment (message classification processing module 150). Regarding a process summary, each message in each thread is classified into a “starting point”, “history”, a “reaction”, and a “separate discussion”. An input is a target outcome ID (for example, a document selected by the viewer 197) and a list of message information forming any thread. An output is a classification value (any of the starting point, the history, the reaction, or the separate discussion) for each message.

In step S602, processes up to step S608 are performed on each message.

In step S604, an “associated outcome ID” is acquired from the message.

In step S606, it is determined whether or not the “associated outcome ID” matches a target outcome ID, and, in a case where both of the IDs match each other, the flow proceeds to step S608, and, if otherwise, the flow returns to step S602.

In step S608, a message classification value is set to a “starting point”.

In step S610, it is determined whether or not processing on all lists has been completed, and, in a case where the processing has been completed, the flow proceeds to step S612 and S636, and, if otherwise, the flow returns to step S602.

In step S612, a “message ID” of the “starting point” message is set to a variable j.

In step S614, it is determined whether or not a message corresponding to j has a “parent message ID”, and, in a case where the message has the “parent message ID”, the flow proceeds to step S616, and, if otherwise, the process is finished (step S699).

In step S616, a message having a message ID matching the “parent message ID” is acquired.

In step S618, a classification value of the acquired message is set to “history”.

In step S620, a “message ID” of the acquired message is set to variables j and k.

In step S622, it is determined whether or not a message corresponding to k has a “child message ID”, and, in a case where the message has the “child message ID”, the flow proceeds to step S624, and, if otherwise, the process is finished (step S699).

In step S624, processes up to step S632 are performed for each “child message ID”.

In step S626, a message having a message ID matching the “child message ID” is acquired.

In step S628, it is determined whether or not a classification value of the acquired message is not defined yet, and, in a case where the classification value is not defined, the flow proceeds to step S630, and, if otherwise, the process is finished (step S699).

In step S630, a classification value of the acquired message is set to a “separate discussion”.

In step S632, a “message ID” of the acquired message is set to the variable k.

In step S634, it is determined whether or not processing on all lists has been completed, and, in a case where the processing has been completed, the process is finished (step S699), and, if otherwise, the flow returns to step S622.

In step S636, a “message ID” of the “starting point” message is set to a variable m.

In step S638, it is determined whether or not a message corresponding to m has a “child message ID”, and, in a case where the message has the “child message ID”, the flow proceeds to step S640, and, if otherwise, the process is finished (step S699).

In step S640, processes up to step S646 are performed for each “child message ID”.

In step S642, a message having a message ID matching the “child message ID” is acquired.

In step S644, a classification value of the acquired message is set to a “reaction”.

In step S646, a “message ID” of the acquired message is set to the variable m.

In step S648, it is determined whether or not processing on all lists has been completed, and, in a case where the processing has been completed, the process is finished (step S699), and, if otherwise, the flow returns to step S638.

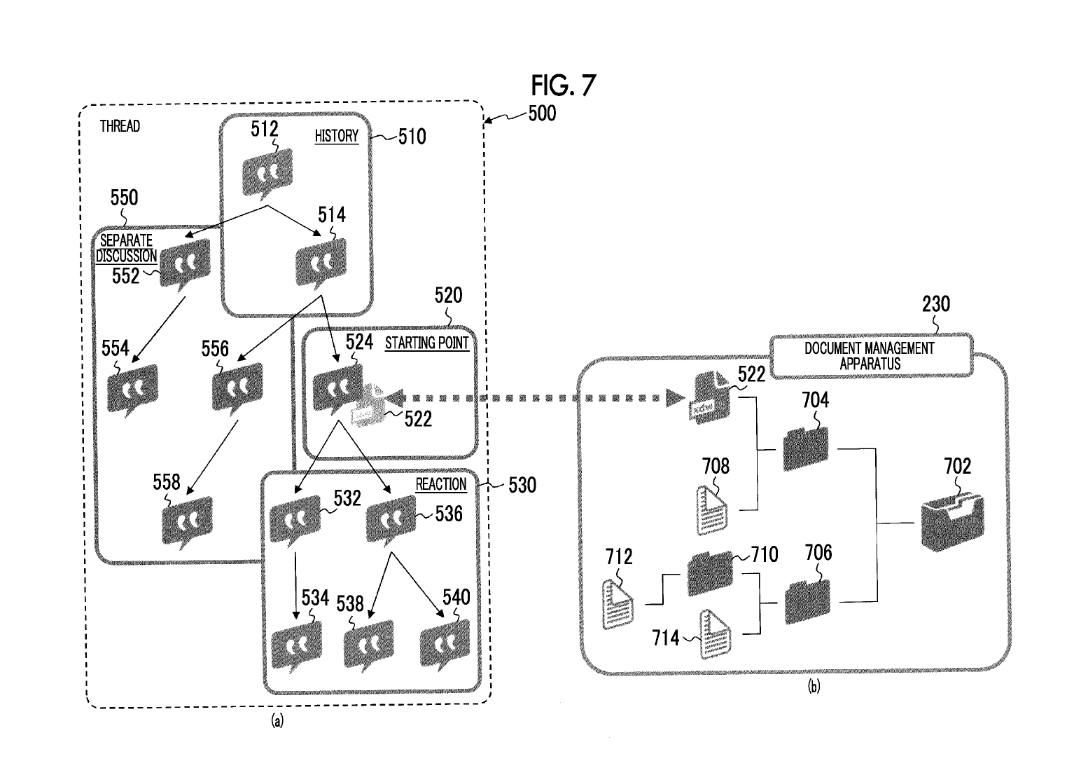

FIG. 7 is a diagram illustrating a process example in the present exemplary embodiment (associated message display processing module 155). A description will be made of a coordination example of an outcome and a message. FIG. 7 illustrates an expression example in a case where an outcome and a message correspond to each other on a one-to-one basis.

A thread 500 illustrated in example in (a) of FIG. 7 is the same as the thread 500 illustrated in the example in FIG. 5. The thread 500 is stored in the message processing apparatus 220.

The example in (b) of FIG. 7 illustrates a file structure in the document management apparatus 230. In other words, there are a folder 704 and a folder 706 as children of a repository root 702, there are an outcome 522 and an outcome 708 as children of the folder 704, there are a folder 710 and an outcome 714 as children of the folder 706, and there is an outcome 712 as a child of the folder 710.

In a case where the outcome 522 is attached to the message 524, an entity of the outcome 522 is stored in any folder of the document management apparatus 230, the document management apparatus 230 side holds an ID of the message, and the message processing apparatus 220 side is in a state of holding a URL of the storage destination.

Consequently, an entity or a storage destination of an outcome can be referred to from a message side (message processing apparatus 220), or a message or a thread associated with (linked with) the outcome can be referred to from a repository side (document management apparatus 230). In other words, the message processing apparatus 220 (message 524) and the document management apparatus 230 (outcome 522) can refer to each other.

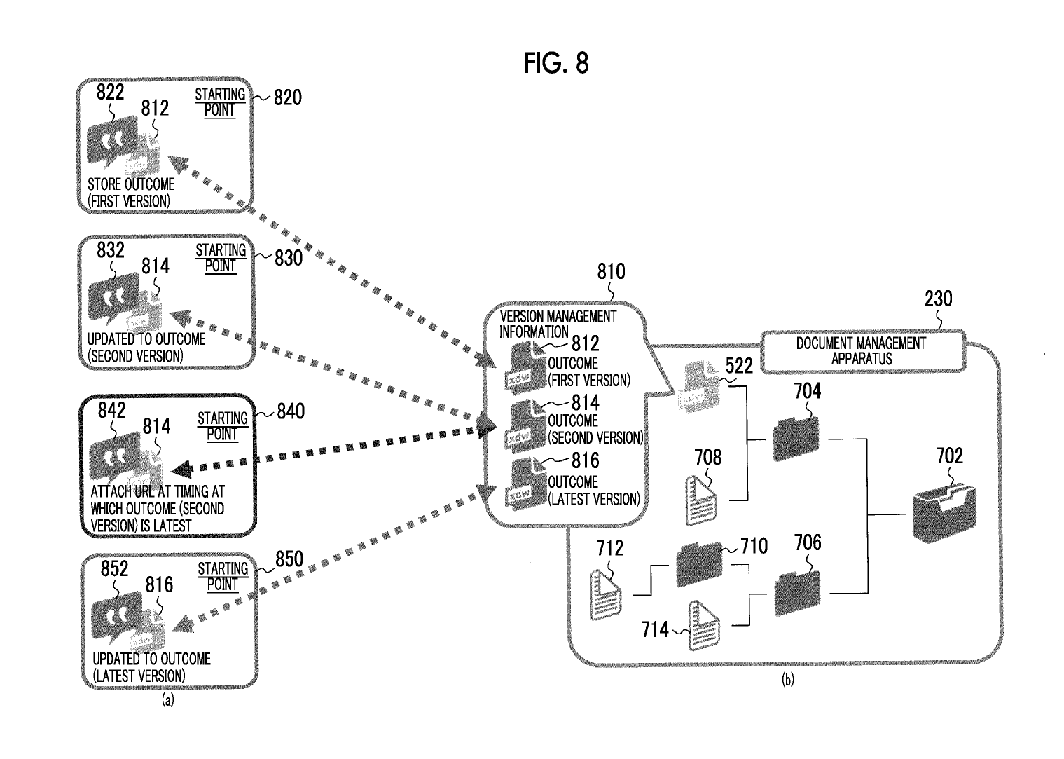

FIG. 8 is a diagram illustrating a process example in the present exemplary embodiment (associated message display processing module 155). A description will be made of coordination of an outcome and a message. FIG. 8 illustrates an expression example in a case where an outcome and a message correspond to each other on an n-to-m basis.

An example in (a) of FIG. 8 illustrates messages in a thread. The messages are stored in the message processing apparatus 220. The example in (b) of FIG. 8 illustrates that an outcome (first version) 812, an outcome (second version) 814, and an outcome (latest version) 816 are added to the document management apparatus 230 illustrated in (b) of FIG. 7 as version management information 810 of the outcome 522.

The outcome (first version) 812 is attached to a message 822 as a starting point 820, and the outcome (first version) 812 is stored as the outcome 522 of the document management apparatus 230. The outcome (second version) 814 is attached to a message 832 as a starting point 830, and the outcome (second version) 814 is stored as the outcome 522 of the document management apparatus 230. A URL of the outcome (second version) 814 is attached to a message 842 as a starting point 840, and the outcome (second version) 814 is stored as the outcome 522 of the document management apparatus 230 in the URL. In this case, plural starting points are set for an identical outcome. Regarding attachment of the URL of the outcome (second version) 814 to the message 842, a version (outcome (second version) 814) at the time of creating the message 842 is regarded to be referred to. The outcome (latest version) 816 is attached to a message 852 as a starting point 850, and the outcome (latest version) 816 is stored as the outcome 522 of the document management apparatus 230.

In a case where the document management apparatus 230 performs version management, and a version of an outcome is updated at the time of creating a message, an ID of a message corresponding to each version is held, and the message processing apparatus 220 side is in a state of holding not only a URL of an outcome storage destination but also a version number.

Consequently, an entity or a storage destination of an outcome can be referred to from a message side (message processing apparatus 220) after a version is specified, or a message or a thread linked with the outcome for each version can be referred to from a repository side (document management apparatus 230). In other words, coordination information with a message for each version of an outcome can be managed.

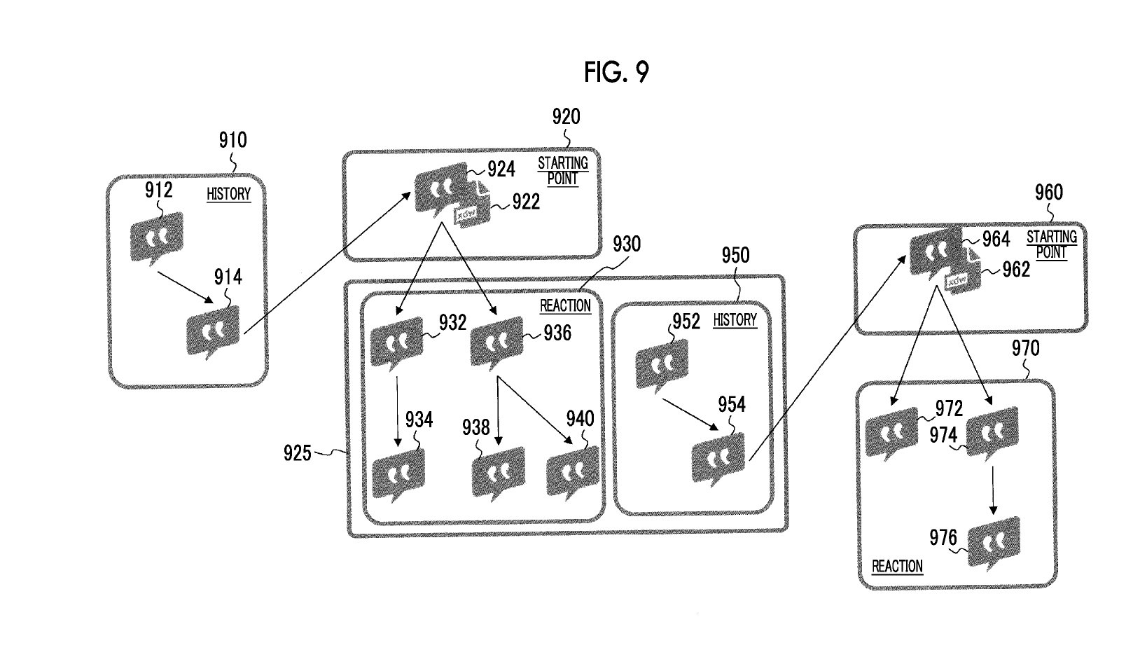

FIG. 9 is a diagram illustrating a process example in the present exemplary embodiment (associated message display processing module 155).

The associated message display processing module 155 may display messages and outcomes in a time series for the respective classifications on a display device of the user terminal 195 as illustrated in the example in FIG. 9.

It is possible to understand the progress until an outcome (outcome 922) designated by the viewer 197 is completed, and the subsequent progress. Specifically, a message (a message 924 attached with the outcome 922) of a starting point 920 is displayed on the upper center part. A message group (a root message 912 and a response message 914) of history 910 is displayed at a left end (old in a time series). A message group is displayed in a message display region 925 of a reaction and the like on the lower center part. A reaction 930 and history 950 are displayed in the message display region 925 of a reaction and the like. Regarding the reaction 930, a message group (a message 932, a message 934, a message 936, a message 938, and a message 940) of the reaction 930 generated after the starting point 920 is displayed, and a message group (a root message 952 and a response message 954) of the history 950 which is generated in the same time period as a time period of the reaction 930 is displayed. A message group (a message 964 attached with an outcome 962) of a starting point 960 is displayed at an upper right end (new in a time series). A message group (a message 972, a message 974, and a message 976) of a reaction 970 is displayed at a lower right end. The outcome 922 is a first version, and the outcome 962 is a version (second version) after the outcome 922.

In a case where a message group associated with an outcome of which any version is managed is displayed, the following messages are targets.

History, a starting point, and a reaction of an outcome (first version)

History, a starting point, and a reaction of an outcome (second version)

History, a starting point, and a reaction of an outcome (final version)

A message group generated in an identical time period may be displayed in a single region such as the message display region 925 of a reaction and the like illustrated in example in FIG. 9. Particularly, a message group of a reaction of the previous version and a message group of history of the next version (a version after the previous version) are surrounded by a frame, and thus a relationship between the message groups in a series of outcomes (series of versions) can be understood.

In a case where message groups are put together as in the message display region 925 of a reaction and the like, a display order may have plural examples as follows.

(Example 1) A reaction and history are mixed and displayed in a time series.

(Example 2) A reaction of an N-th version and history of an (N+1)-th version are displayed in this order. For example, as illustrated in the example in FIG. 9, the reaction 930 and the history 950 are displayed from the left in the message display region 925 of a reaction and the like.

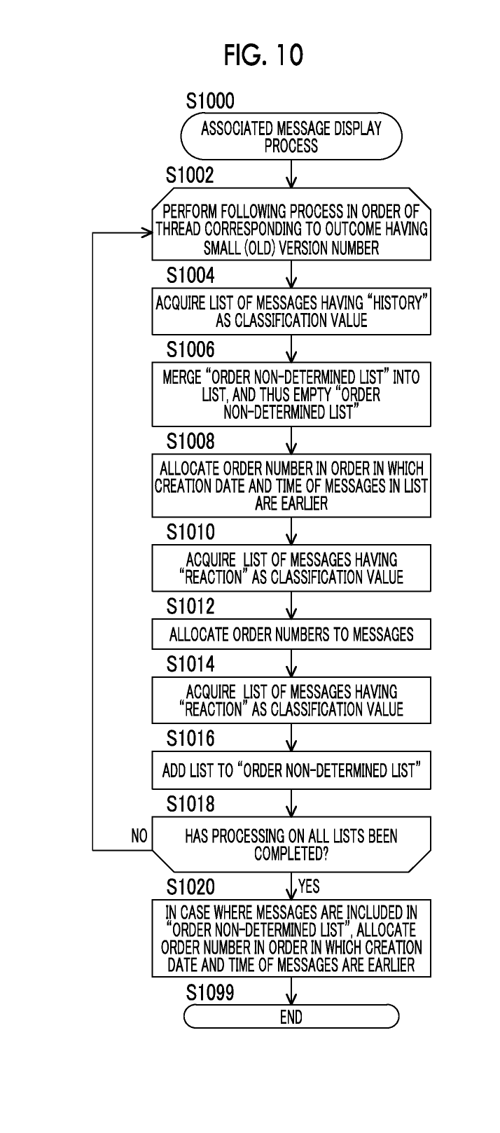

FIG. 10 is a flowchart illustrating a process example in the present exemplary embodiment (associated message display processing module 155). Regarding a process summary, a message display order is determined by performing a combination process for each message classification of each thread on the basis of classification information. An input is each piece of thread information (list of classified messages). An output is a message list with an order number. A message display order (display position) may be determined according to this order number.

An allocated order number begins from 0, and is incremented (added by 1) every allocation.

In step S1002, processes up to step S1016 are performed in an order of a thread corresponding to an outcome having a small (old) version number.

In step S1004, a list of messages having “history” as a classification value is acquired.

In step S1006, an “order non-determined list” is merged into the list, and thus the “order non-determined list” is emptied.

In step S1008, an order number is allocated in an order in which the creation date and time of the messages in the list are earlier.

In step S1010, a list of messages having a “starting point” as a classification value is acquired.

In step S1012, order numbers are allocated to the messages.

In step S1014, a list of messages having a “reaction” as a classification value is acquired.

In step S1016, the list is added to the “order non-determined list”.

In step S1018, it is determined whether or not processing on all lists has been completed, and, in a case where the processing has been completed, the flow proceeds to step S1020, and, if otherwise, the flow returns to step S1002.

In step S1020, in a case where messages are included in the “order non-determined list”, an order number is allocated in an order in which the creation date and time of the messages are earlier.

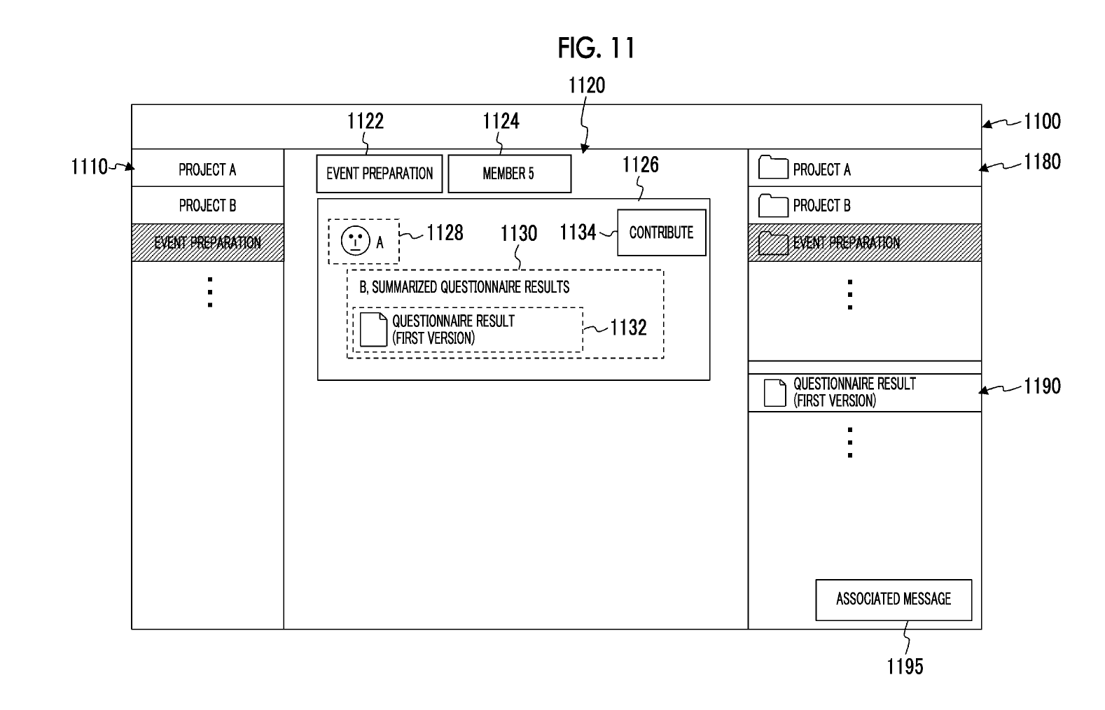

FIG. 11 is a diagram illustrating a display example in the present exemplary embodiment. FIG. 11 illustrates an example of a user interface for message contribution (transmission) in the present exemplary embodiment.

A screen 1100 is displayed on a display device of the user terminal 190.

A project list display region 1110, a message display region 1120, an outcome folder display region 1180, an outcome list display region 1190 are displayed on the screen 1100.

A project in which the contributor 192 participates is displayed in the project list display region 1110. For example, a case where “event preparation” is selected is displayed.

An event name display region 1122, a number-of-member display region 1124, and a message contribution region 1126 are displayed in the message display region 1120. The “event preparation” selected in the project list display region 1110 is displayed in the event name display region 1122. The number of members participating in the project is displayed in the number-of-member display region 1124. A user display region 1128, a message content description region 1130, and a contribution button 1134 are displayed in the message contribution region 1126. The name (A) of the contributor 192 is displayed in the user display region 1128. The contributor 192 describes a message in the message content description region 1130. An attached document is copied to an attached document 1132. In a case where the contribution button 1134 is selected, a message attached with a “questionnaire result (first version)” which is an outcome in the message content description region 1130 is contributed to the message processing apparatus 220.

A folder (storage location) is prepared in the document management apparatus 230 according to a project, and the name of the folder is displayed in the outcome folder display region 1180. For example, a case where an “event preparation” folder is selected is displayed.

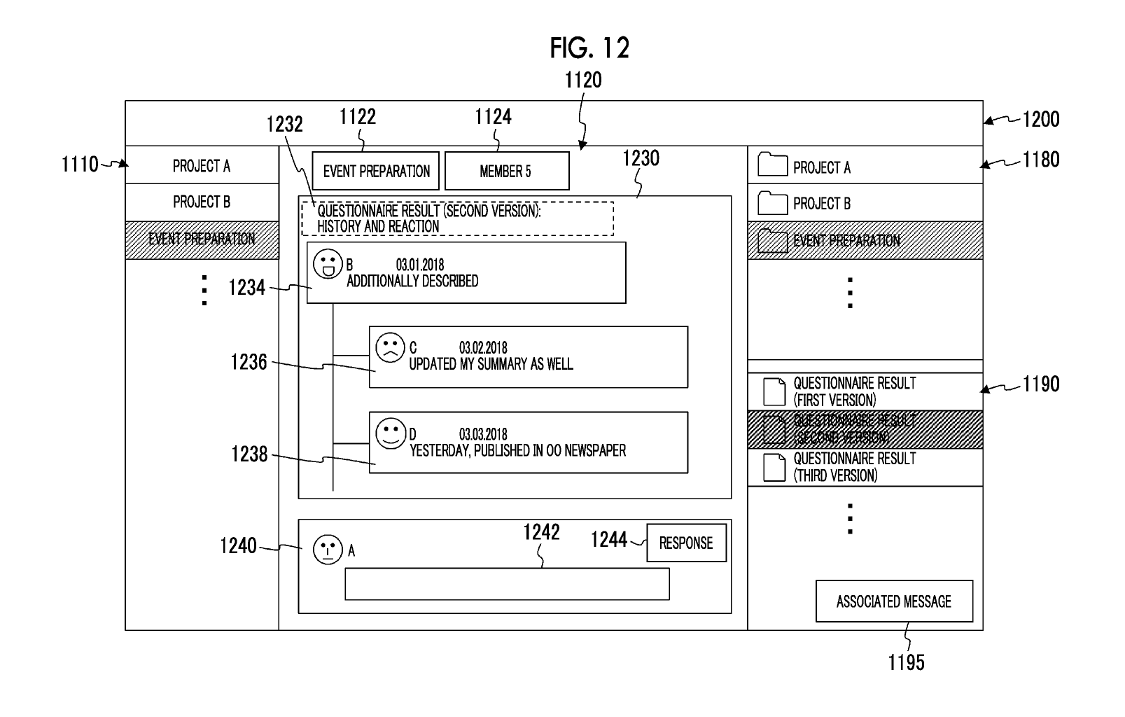

A document (outcome) in the “event preparation” folder is displayed in the outcome list display region 1190. In this example, a “questionnaire result (first version)” which is previously contributed is displayed. An associated message button 1195 is displayed in the outcome list display region 1190. In a case where the associated message button 1195 is selected, a screen 1200 illustrated in an example in FIG. 12 is displayed. At this time, the user terminal 190 becomes the user terminal 195, and the contributor 192 becomes the viewer 197.

FIG. 12 is a diagram illustrating a display example in the present exemplary embodiment. FIG. 12 illustrates an example of a state in which a message is further contributed in the example in FIG. 11, a version of an outcome also progresses, and the “questionnaire result (first version)”, a “questionnaire result (second version)”, a “questionnaire result (third version)”, and the like are stored.

The screen 1200 is displayed on a display device of the user terminal 195.

The project list display region 1110, the message display region 1120, the outcome folder display region 1180, and the outcome list display region 1190 are displayed on the screen 1200.

The project list display region 1110 and the outcome folder display region 1180 are equivalent to those illustrated in the example in FIG. 11. It is assumed that the associated message button 1195 is selected in a state in which the “questionnaire result (second version)” in the outcome list display region 1190 is selected.

The event name display region 1122, the number-of-member display region 1124, a history/reaction message display region 1230, and a response message contribution field 1240 are displayed in the message display region 1120. The event name display region 1122 and the number-of-member display region 1124 are equivalent to those illustrated in the example in FIG. 11.

A title display region 1232, a message display region 1234, a message display region 1236, and a message display region 1238 are displayed in the history/reaction message display region 1230. A message group (the message display region 1234, the message display region 1236, and the message display region 1238) classified into a reaction and history is displayed with the message attached with the “questionnaire result (second version)” as a starting point.

A picture and the name of B which is a sender, the transmission date and time: 2018. 03. 01, a message content “additionally described” are displayed in the message display region 1234. A picture and the name of C which is a sender, the transmission date and time: 2018. 03. 02, a message content “updated my summary as well” are displayed in the message display region 1236.

A picture and the name of D which is a sender, the transmission date and time: 2018. 03. 03, a message content “yesterday, published in the OO newspaper” are displayed in the message display region 1238.

The response message contribution field 1240 has a message content description region 1242 and a response button 1244. The response message contribution field 1240 is used in a case where any message is selected, and a response to the message is made. The response message contribution field 1240 is equivalent to the message contribution region 1126 illustrated in the example in FIG. 11. However, since a response to the selected message is made, in the thread, a relationship is formed such that the selected message is a parent, and a message given in response to the selected message is a child. Of course, in a case where a message attached with a document is transmitted here, the message is classified as a starting point.

In response to a scroll operation in the message display region 1120, “history”, a “starting point”, and a “reaction” of the “questionnaire result (first version)” are subsequently displayed after messages of “history”, a “starting point”, and a “reaction” of the “questionnaire result (second version)”, and thus the viewer 197 can trace a flow of communication in a whole outcome.

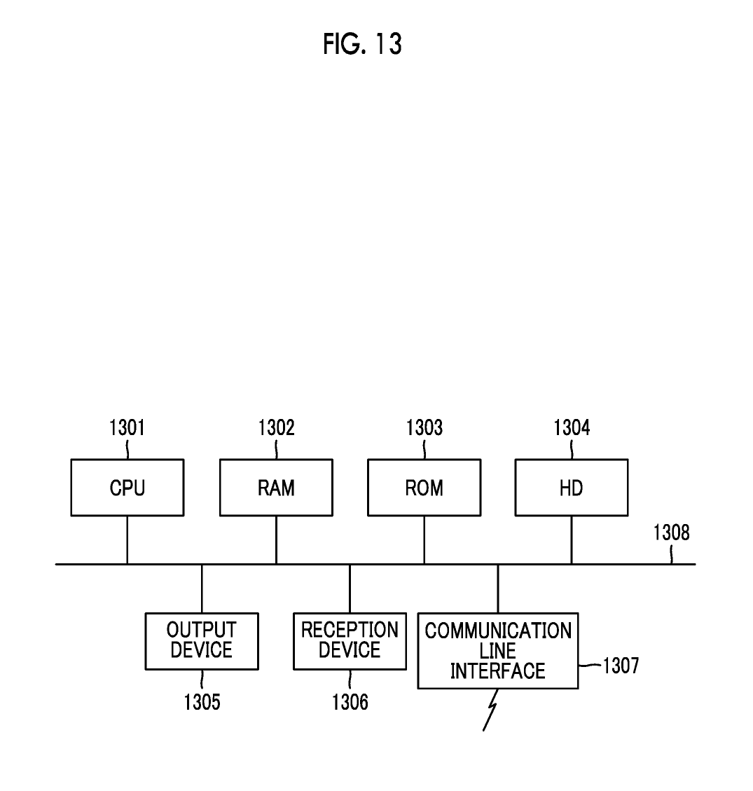

A hardware configuration of a computer executing a program as the present exemplary embodiment is a hardware configuration of a general computer as exemplified in FIG. 13, and the computer is, specifically, a personal computer or a computer serving as a server. In other words, as a specific example, a CPU 1301 is used as a processing unit (calculation unit), and a RAM 1302, a ROM 1303, and an HD 1304 are used as a storage device. For example, a hard disk or a solid state drive (SSD) may be used as the HD 1304. The computer includes the CPU 1301 executing programs such as the data registration module 125, the message/outcome registration processing module 130, the association processing module 135, the data display module 140, the thread extraction module 145, the message classification processing module 150, and the associated message display processing module 155; the RAM 1302 storing the programs or data; the ROM 1303 storing a program or the like for activating the computer; the HD 1304 which is an auxiliary storage device (which may be a flash memory or the like) functioning as the message database 110, the message and outcome association DB 115, and the outcome DB 120; a reception device 1306 which receives data on the basis of a user's operation (including an action, a voice, a visual line, and the like) on a keyboard, a mouse, a touch screen, a microphone, or a microphone (including a visual line detection camera or the like); an output device 1305 such as a CRT, a liquid crystal display, or a speaker; a communication line interface 1307 for connection to a communication network such as a network interface card; and a bus 1308 connecting the above-described elements to each other for exchanging data. Such plural computers may be connected to each other via a network.

Among the above-described embodiments, in a case of the embodiment based on a computer program, the computer program which is software is read to a system having the present hardware configuration, and the embodiment is realized through cooperation between the software and the hardware resources.

The hardware configuration illustrated in FIG. 13 corresponds to one configuration example, and the present exemplary embodiment is not limited to the configuration illustrated in FIG. 13, and any configuration in which the modules described in the present exemplary embodiment can be executed may be used. For example, some of the modules may be configured with dedicated hardware (for example, an application specific integrated circuit (ASIC)), some of the modules may be provided in an external system, and may be connected to a communication line, and such plural systems illustrated in FIG. 13 may be connected to each other via a communication line so as to operate in cooperation therebetween. Particularly, the modules may be incorporated not only into a personal computer but also into a portable information communication apparatus (including a mobile phone, a smart phone, a mobile apparatus, a wearable computer, and the like), an information appliance, a robot, a copier, a facsimile, a scanner, a printer, a multi-function peripheral (an image processing apparatus having two or more functions of a scanner, a printer, copier, and a facsimile).

The above-described embodiment may be modified as follows.

As a difference between versions of an outcome, a reflected message content may be extracted. The reflected part may be marked (which is displayed differently from other parts, for example, is displayed red) in the message such that the message reflected in the outcome can be focused. Manual marking may be performed.

Particularly, a message reflected in an outcome of the latest version may be marked. Consequently, a “currently reflected message” can be noticed.

In addition to an updated version, in identical history or reaction, a file having an identical name which is newly additionally registered is a separate outcome, but may be regarded to be an identical outcome, and may be displayed in association. In addition to history and a reaction, a “separate discussion” may be displayed as supplementary information, and an “outcome created in the separate discussion” may be extracted as an “associated outcome”, and may be used for outcome retrieval in an auxiliary manner. In display of a message in the associated message display processing module 155, a message may not be displayed without being changed, and a summarized message may be displayed.

A restriction may be given to a specific version, and “history up to the version” may be restricted and displayed.

In the associated message display processing module 155 or the user terminal 195, in a case where an outcome is displayed, a change location and a message related to the change location may be displayed. For example, a document display application (for example, a PDF viewer) side may display a message tree illustrated in the example in FIG. 5 as supplementary information.

On the basis of correction (version update) of an outcome, a reflected message and a corrected portion may be specified and be stored in a pair. In the substrate document correction, it may be determined whether or not the pair is maintained, and, in a case where the pair is not maintained, a warning may be displayed at the time of preservation.

An outcome which is regarded to be the latest outcome may be specified from among many attached outcomes in a thread. In a case where an operation of correcting other outcomes is detected, a warning may be performed. For example, in a case where a file attached to a message corresponding to history of a message attached with an outcome is updated, a warning is displayed.

Plural messages maybe associated with an outcome. This is so that, for example, in a case where certain plural messages are reflected in an outcome in a review, the plural messages and the outcome after the reflection are coordinated with each other.

The program may be stored on a recording medium so as to be provided, and the program may be provided by using a communication unit. In this case, for example, the program may be understood as the invention of a “non-transitory computer readable medium storing the program”.

The “non-transitory computer readable medium storing the program” indicates a computer readable recording medium storing the program, used to install, execute, and distribute the program.

The recording medium includes, for example, “a DVD-R, a DVD-RW, a DVD-RAM, or the like” which is a digital versatile disc (DVD) and is a standard defined in the DVD forum, and “a DVD+R, DVD+RW, or the like” which is a standard defined in the DVD+RW, a compact disc (CD) read only memory (CD-ROM), a CD recordable (CD-R), or a CD rewritable (CD-RW), a Blu-ray (registered trademark) disc, a magnetooptical disc (MO), a flexible disk (FD), a magnetic tape, a hard disk, a read only memory (ROM), an electrically erasable programmable read only memory (EEPROM) (registered trademark), a flash memory, a random access memory (RAM), and a secure digital (SD) memory card.

The whole or a part of the program may be recorded on the recording medium so as to be preserved or distributed. The program may be transmitted through communication, for example, by using a wired network used for a local area network (LAN), a metropolitan area network (MAN), a wide area network (WAN), the Internet, an intranet, or an extranet, a wireless communication network, or a combination thereof, and may be carried via a carrier wave mounted therewith.

The program may be a part of the whole of another program, or may be recorded on a recording medium along with a separate program. The program may be divided and recorded on plural recording media. The program may be recorded in any restorable aspect such as compression or encryption.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an outcome management unit that manages an outcome;
a message management unit that manages a message corresponding to the outcome; and
a presentation unit that classifies and presents the message according to a relationship between the outcome and the message.

2. The information processing apparatus according to claim 1,
wherein the outcome management unit manages a version of an outcome.

3. The information processing apparatus according to claim 1,
wherein the relationship between the outcome and the message includes one or more of a starting point, history, a reaction, or a separate discussion.

4. The information processing apparatus according to claim 3,
wherein a message associated with a preset outcome is set as the starting point in a message group having a tree structure.

5. The information processing apparatus according to claim 4,
wherein, in the message group, messages from a message at a root node to a message at a node before the message serving as the starting point are set as the history.

6. The information processing apparatus according to claim 4,
wherein, in the message group, a message at a descendant node after the message serving as the starting point is set as the reaction.

7. The information processing apparatus according to claim 4,
wherein, in the message group, a message at a node not having a relationship of the history or the reaction with the message serving as the starting point is set as the separate discussion.

8. The information processing apparatus according to claim 1,
wherein the presentation unit presents the message classified as the relationship for each outcome.

9. The information processing apparatus according to claim 8,
wherein the presentation unit presents a message in another outcome associated with the message.

10. A non-transitory computer readable medium storing an information processing program causing a computer to function as:
an outcome management unit that manages an outcome;
a message management unit that manages a message corresponding to the outcome; and
a presentation unit that classifies and presents the message according to a relationship between the outcome and the message.

11. An information processing apparatus comprising:
outcome management means for managing an outcome;
message management means for managing a message corresponding to the outcome; and
presentation means for classifying and presenting the message according to a relationship between the outcome and the message.
